(19) United States
(12) Patent Application Publication
(10) Pub. No.: US 2007/0300242 A1
(43) Pub. Date: Dec. 27, 2007

(54) Automated execution of a business service as an electronic service

(75) Inventors: Erin A. Boyd, Three Forks, MT (US); Stewart J. Hyman, Richmond Hill (CA); Heiko Ludwig, New York, NY (US); James T. Smith, Boulder, CO (US); Michael J. Spisak, East Northport, NY (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/472,788

(22) Filed: Jun. 22, 2006

(51) Int. Cl. G06F 9/46

(52) U.S. Cl. 719/330

(57) ABSTRACT

A method defines an execution of a business service by an electronic service. The method includes steps of: defining at least one canonical data schema containing data type specifications in an electronic services registry; defining at least one electronic service interface specification in the electronic services registry, the electronic service interface specification defining messages being received and sent by a service, the message definitions referring to one or more of the data type specifications, and also containing addressing and encoding information for the delivery and receiving of messages to and from the service; and defining business service specifications in a business services registry, referring in the specification to an electronic service specification.

### CROSS-REFERENCE TO RELATED APPLICATIONS

Not applicable.

### STATEMENT REGARDING FEDERALLY SPONSORED-RESEARCH OR DEVELOPMENT

Not applicable.

### INCORPORATION BY REFERENCE OF MATERIAL SUBMITTED ON A COMPACT DISC

Not Applicable.

### FIELD OF THE INVENTION

The invention disclosed broadly relates to the field of business service applications and more particularly relates to the field of executing electronic services for business service requests automatically.

### BACKGROUND OF THE INVENTION

It has become common for business services to be delivered by servers to clients (e.g., by application service providers). A service requester may be an application program requiring the service of another program. The programs however may use different data formats or be otherwise incompatible. Moreover, many business service providers are heterogeneous and they use different data structures. Such business service providers use the electronic services of third parties and those service providers may not be fully compatible with the business server providers. In such cases directories are used but the directories do not automatically integrate with a service provider. Therefore there is a need for executing electronic services for a business service automatically.

### SUMMARY OF THE INVENTION

Briefly, according to an embodiment of the invention, a method defines execution of a business service by an electronic service. The method includes steps of defining at least one canonical data schema and at least one electronic service interface specification in the electronic services registry. The electronic service interface specification defines messages being received and sent by a service. The message definitions refer to one or more of the data type specifications, and also contain addressing and encoding information for the delivery and receipt of messages to and from the service. The business service registry comprises a business services specification that defines the business service provided.

### BRIEF DESCRIPTION OF THE DRAWINGS

FIG. 1 is a business model diagram showing a system to facilitate the processing of a business service request, according to an embodiment of the invention.

FIG. 2 shows a business service delivery system binding mechanism.

FIG. 3 shows a request formatting mechanism.

FIG. 4 shows an execution definition mechanism.

FIG. 5 shows a binding and execution mechanism.

FIG. 6 shows a multi-provider binding and execution mechanism.

FIG. 7 shows a human self-serve and approval method.

FIG. 8 shows provider selection based on policy.

FIG. 9 illustrates a block diagram of an information handling system according to an embodiment of the invention.

### DETAILED DESCRIPTION

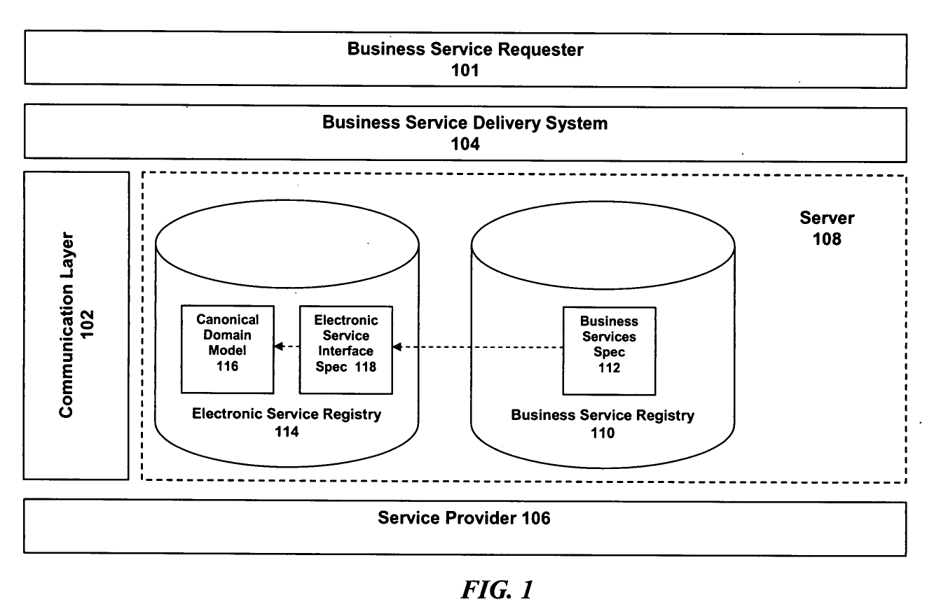

Referring to FIG. 1, a system 100 facilitates the servicing of a service request, made by a business service requestor 101, of a business service. An electronic service performed by a service provider 106. A business service delivery system 104 services service requests by customers, or service requesters 101. Requests can be received by the business service delivery system 104 in many ways and formats, e.g., as Web services calls using SOAP (Simple Object Access Protocol) over HTTP (hypertext transfer protocol). The business service delivery system 104 is coupled to a server 108, which includes two registries: a business service registry 110 and an electronic service registry 114. The business service registry 110 contains a set of business service specifications 112 that describe the properties of the service, including the data structures of input data to be provided by a requester 101, estimated duration of the service, cost, and other metadata. The electronic services registry 114 contains a set of canonical domain models 116, which are commonly agreed upon data structure definitions, and a set of electronic service interface specifications 118, which comprise a formal definition of the electronic services interface, in the form of a WSDL (Web Services Description Language) definition of operations and messages used in these operations. The WSDL file also contains the binding information that is needed to establish communication to a provider 106 of the electronic service to invoke the service performance. A communication layer 102 connects the business service delivery system 104 and the provider 106 of the electronic service. Different services can have different providers.

The elements in a registry establish the relationship between the business service and the electronic service. The business service specification 112 refers to an electronic service interface specification 118, by pointing to its WSDL file and a specific operation defined within the WSDL file that describes the interface to the implementation of the business service. The WSDL file includes a reference to the canonical domain model 116, which is an XML (extensible markup language) schema file and uses types and elements defined in this schema to define the message content of operations.

Other interface descriptions such as CORBA IDL (common object request broker architecture, interface definition language) and other formats may be used to describe canonical domains such as XML document type definitions. Having defined the relationship between a business service offered to a requester 101 and an electronic service, implemented by a provider 106 using the meta-data specifications in the registries 110 and 114, the server 108 can facilitate a service request from the business service requester 101 to a service provider 106 by establishing a communication channel 120 to a service provider 106 for a particular business service.

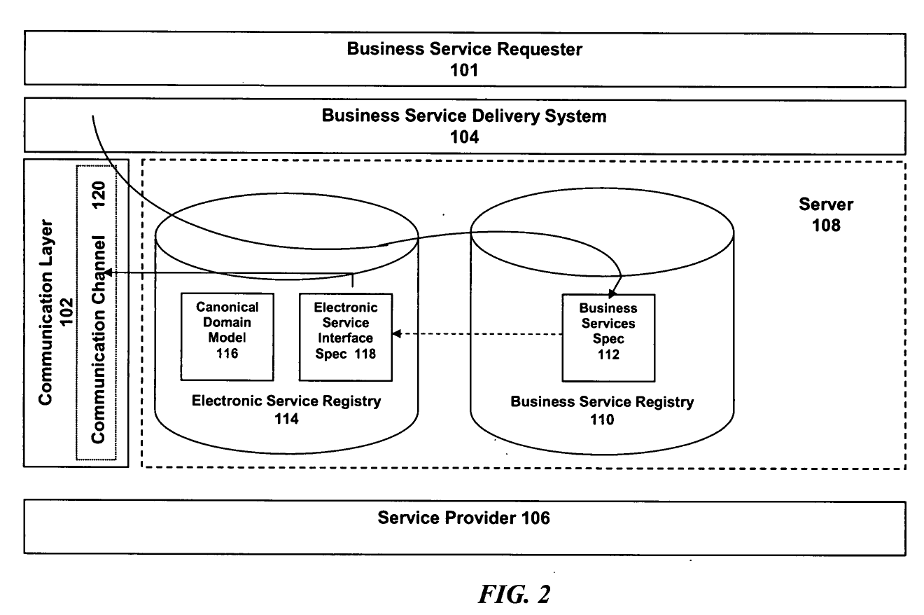

Referring to FIG. 2, we illustrate establishing a communication channel for providing business services to a requester. Upon receiving a service request, the business service delivery system 104 retrieves the associated business service specification 112 from the business services registry 110. Using the reference to the electronic service interface specification 118 contained in the business services specification 112, the corresponding specification 118 of the electronic service can be retrieved. This WSDL document contains the binding information, which can be used to establish a communication channel 120 to the electronic service provider 106. This is usually done by generating or configuring a client stub to the electronic service.

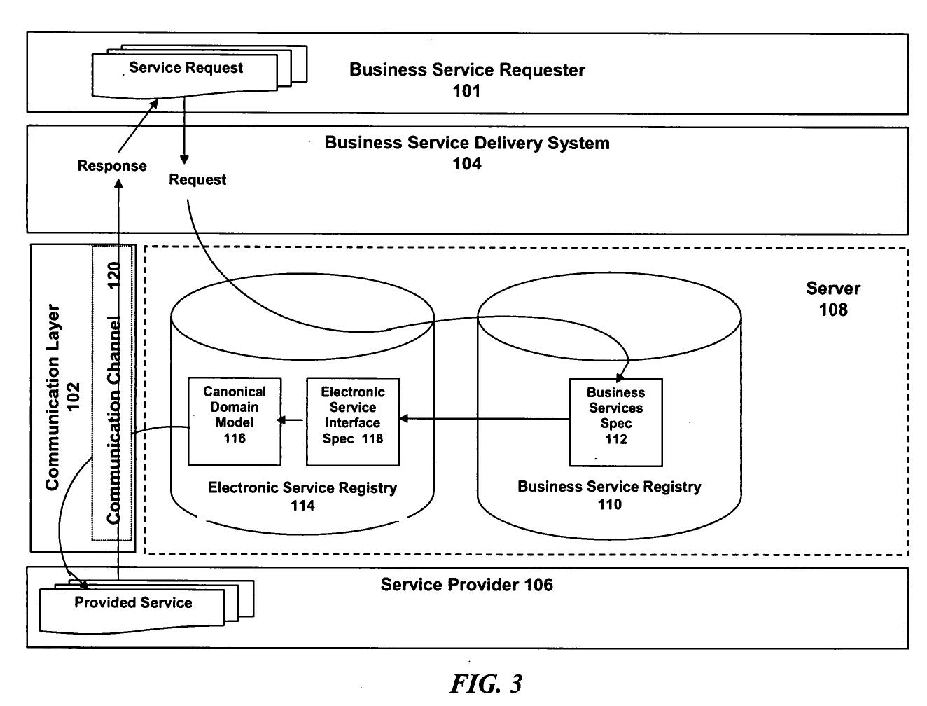

Having established the communication channel 120, the electronic service can be used to satisfy business service requests, as outlined in FIG. 3. Referring to FIG. 3, we show invoking of an electronic service for a business service request. The business service requester 101 submits the service request to the delivery system 104. The delivery system 104 looks up the business service specification 112 and retrieves a link to the established communication channel 120 to the associated electronic service 118. It uses the canonical domain model 116 to encode the service request data in the right format as defined in the WSDL and associated canonical domain form a schema 116.

The established communication channel 120 is used to submit a service invocation to the service provider 106. The service provider 106 processes the operation and sends the result back, as defined in the interface specification 118, through the communication channel 120. The business service delivery system 104 then interprets the results according to the canonical domain model 116 and communicates the result of the service request back to the business service requester 101.

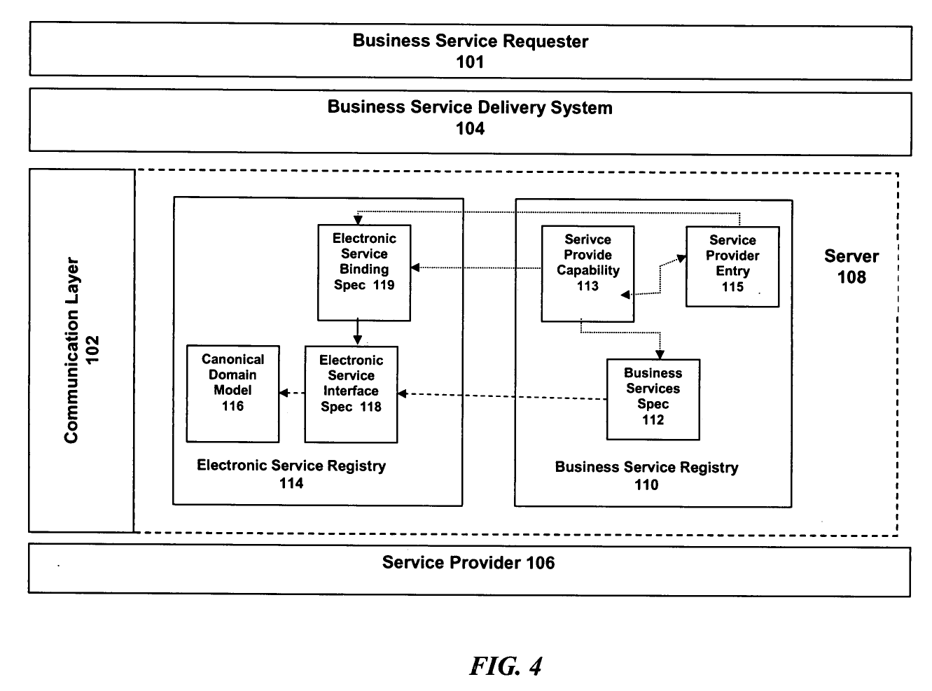

Referring to FIG. 4, we show the system 100 configured to use multiple service providers. For performance, load management, or business reasons, a business service delivery system operator may want to have multiple service providers to implement the same type of service. This requires a different and enhanced set of specifications in the registries 114 and 110 of the embodiment herein described.

In the business service registry 110, service providers 106 must be maintained as separate entities. Each service provider 106 has an entry 115 that defines a unique identifier, contact data, accounting information and other business relevant data. For each type of business service that a service provider can perform, the repository contains a service provider capability specification 113, associating the service provider with a particular business service specification.

The electronic service registry 114 contains the above-mentioned canonical domain model 116 and an electronic interface specification 118, a WSDL file defining operations and message formats, referring to the XML schema representing the canonical domain mode 116, but does not contain any binding information because this part will be different from service provider to service provider.

Finally, the electronic service registry 114 also contains an electronic service binding specification 119. This is a WSDL file that refers to or includes the WSDL of the interface specification and additionally defines the specifics of how to establish the communication channel 120 to a specific service provider, the binding section of a WSDL file.

In the case of multiple service providers, associations between elements of the business service registry 110 and the electronic service registry 114 are different from the single provider case. A service provider capability 113 (in the business service registry 110) refers to an electronic service binding specification 119 (in the electronic service registry 114), while the business service specification 112 refers to the electronic service interface specification 118, which does not contain the binding information in the multi-provider case. This enhanced registry structure of FIG. 4 can be used to bind the same type of business service to multiple, different service providers, each adhering to the electronic service interface specification 118 and the canonical domain model 116.

Upon a service request, or prior to receiving service requests, the business delivery system 104 establishes communication channels 120 to the electronic services implementing business services. For a business services specification, the delivery system 104 retrieves the set of service provider capabilities 113 that is associated to it, representing the different service providers. A service provider is chosen with which to bind. Using the reference from a service provider capability 113 to an electronic service binding specification 119, and, in turn it is a reference to the corresponding interface specification, the delivery system 104 obtains all necessary information to establish a communication channel 120 to the specific electronic service implementation of a service provider.

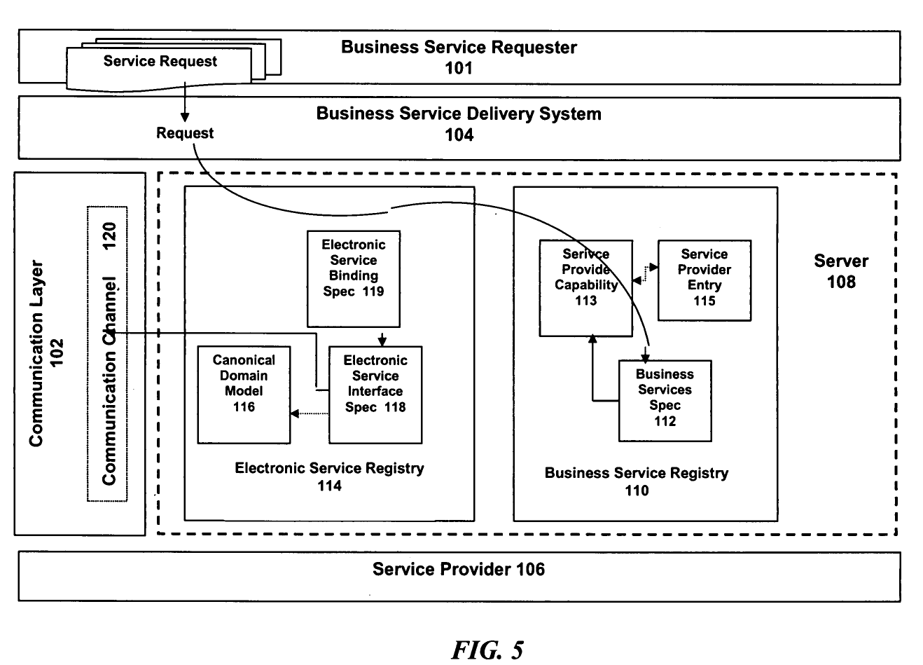

Referring to FIG. 5 we show binding to a multi-service provider environment. Using these WSDL files of the binding and contained interface specifications, a stub is generated that implements the communication channel 120. This process can be repeated for all service providers either when they are chosen the first time to perform, upon their registration to the system, or at any other convenient time, e.g., system reboot or a maintenance window.

When communication channels 120 are set up, electronic services can be used by a business service delivery system 104 to answer service requests, as follows. When a service request arrives in the business service delivery system 104, it is associated with a business service specification 112. Subsequently, the service provider 106 is chosen to perform this service. Many criteria can be used for this decision such as price, availability, reputation and other parameters, as well as a combination of parameters such as a score. The association with an interface binding specification 119 is used to retrieve the communication channel 120 to the service implementation of the chosen service provider. Using the reference through the electronic service interface specification 118 to the canonical domain model 116, the business service delivery system 104 encodes the data of the service request in the commonly agreed format. Then, the business service delivery system 104 invokes the electronic service through the communicational channel 120 to it.

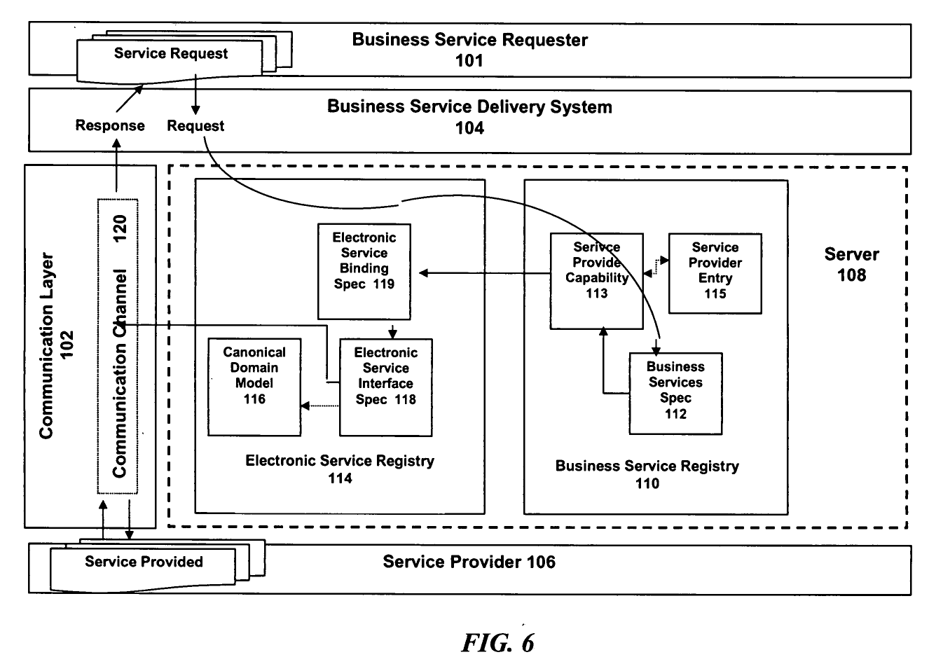

Referring to FIG. 6, we show an electronic service invocation in a multi-service provider context. The electronic service 106 receives and processes the request and then sends it back through the communication channel 120 to the business delivery system 104, where it can be interpreted according to the canonical domain format 116 and a response to the business service requester 101 can be created. An important aspect of this invention is the maintenance of the two registries 114 and 110. The information in the registries 114 and 110 is being added and maintained by different parties. The operators of the business delivery system 104 use a user interface application to create business services specifications 112. They also use an interface to create electronic service interface specifications 118 and the canonical domain models 116. Service providers must provide the data representing their entry 115, their capabilities 113 and the electronic service binding information 119.

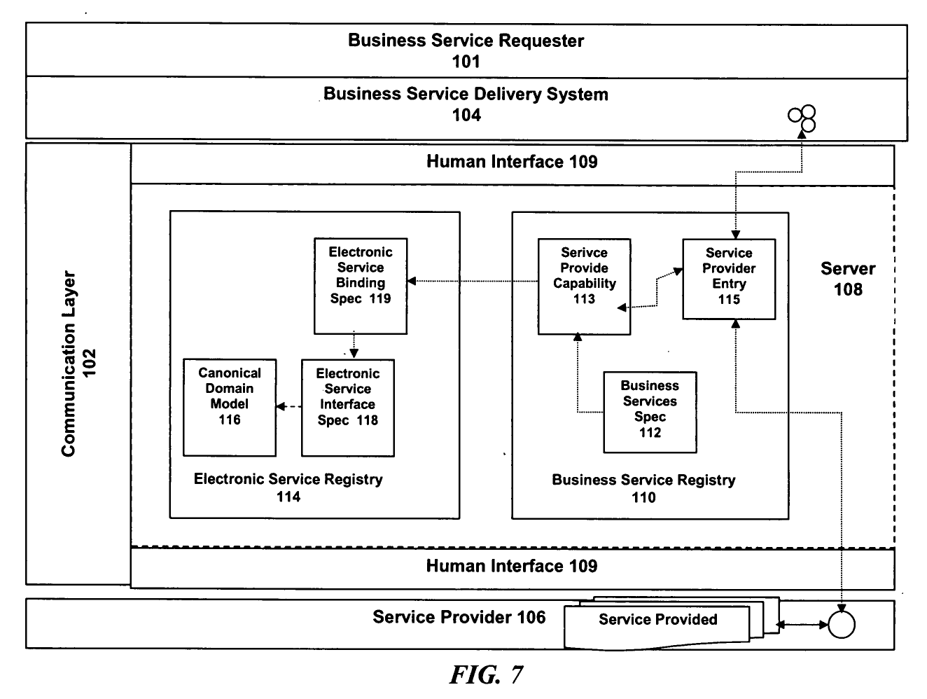

Referring to FIG. 7, we show self-registration by service providers. In this model, decision-making on service provider approval was deferred to human input 109. In a self-service model, as outlined in FIG. 7, service provider employees can use a user interface application such as a Web client application to enter this information and submit it for approval. Subsequently, business service delivery employees can inspect the submitted information and approve or reject the submitted data. If approved, the service provider capability 113 and the referred electronic service binding information 119 can be used to establish a communication channel 120 to this specific service provider 106 of an electronic service.

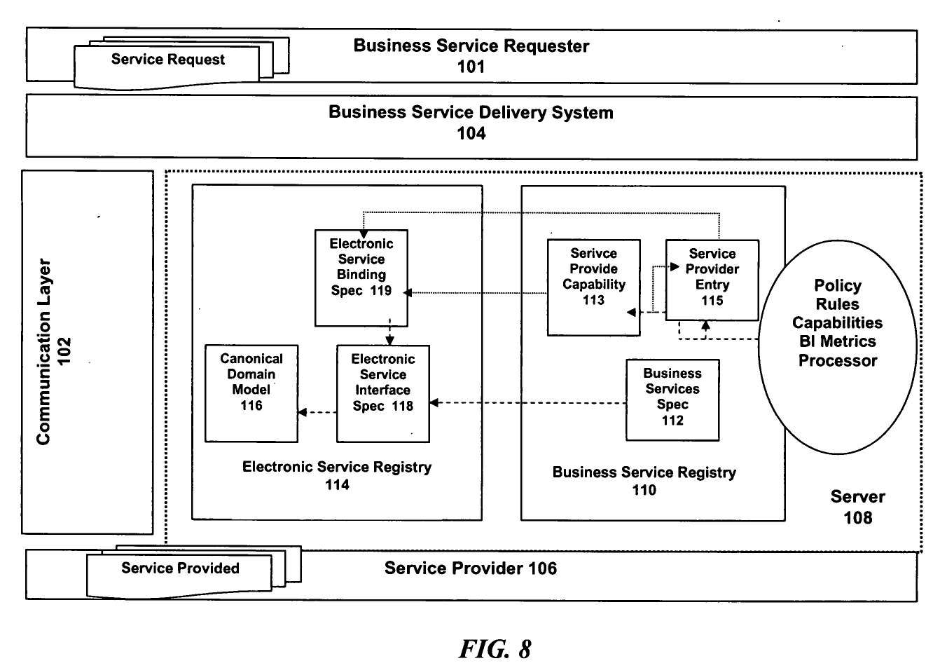

FIG. 8 outlines how a policy-based mechanism can be used for automating the approval process. Policies are represented in rules referring to capabilities 113 of service providers and metrics collected on past service provider behavior, e.g., percentage of service request completion in time. A rules processor can interpret the rules against the capabilities 113 and current metric values and make a decision on approving or rejecting a service provider 106 to perform a specific electronic service for a business service.

A policy-based decision-making mechanism can also be used for choosing a service provider 106. A system according to the invention can also be used if business services requested by business service requests are complex and must be decomposed into atomic services, which are subsequently performed as electronic services by service providers as defined above.

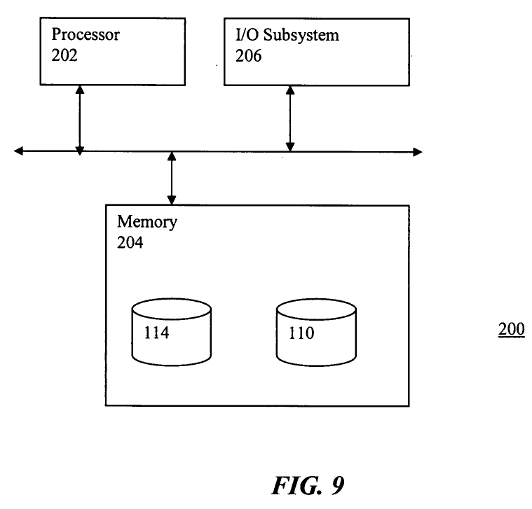

Referring to FIG. 9, there is shown a block diagram of an information handling system 200 according to another embodiment of the invention. The system 200 comprises a processor 202, a memory 204, and an input/output (I/O) subsystem 206. The memory 204 represents either a random-access memory or mass storage. It can be volatile or non-volatile. The system 200 can also comprise a magnetic media mass storage device such as a hard disk drive.

The I/O subsystem 206 may comprise various end user interfaces such as a display, keyboards, and a mouse. The I/O subsystem 206 may further comprise a connection to a network such as a local-area network (LAN) or wide-area network (WAN) such as the Internet. This system 200 can be used as a server for storing the electronic service registry 114 and the business service registry 110. What has been shown and discussed is a highly-simplified depiction of a programmable computer apparatus. Those skilled in the art will appreciate that other low-level components and connections are required in any practical application of a computer apparatus.

According to another embodiment of the invention, a computer readable medium, such as a CDROM or DVD can include program instructions for operating the programmable computer 200 according to the invention. Therefore, while there have been described what are presently considered to be the preferred embodiments, it will understood by those skilled in the art that other modifications can be made within the spirit and scope of the invention.

We claim:

1. A method for defining execution of a business service by an electronic service, the method comprising:
defining at least one canonical data schema containing data type specifications;
defining at least one electronic service interface specification, the electronic service interface specification defining messages being received and sent by the electronic service, the messages defined referring to one or more of the data type specifications, and the messages defined also comprising addressing and encoding information for the delivery and receiving of messages to and from the electronic service; and
defining a business service specification defining services performed by a business service provider and referring to the electronic service interface specification.

2. The method of claim 1 further comprising:
binding the business service to the electronic service specification, the binding step comprising:
retrieving the business service specification;
retrieving the electronic service interface specification using the reference to the electronic service interface specification; and
setting up an electronic communication channel between the electronic service provider and the business service provider, in accordance with addressing and encoding information contained in the electronic service interface specification.

3. The method of claim 1 wherein the business services specification is stored in a business service registry, and the electronic service interface specification and the canonical domain model are stored in an electronic service registry.

4. A method for servicing a request for a business server, the method comprising
receiving, from a service requester, the request for a business service;
retrieving a business service specification associated with the business service requested, the business service specification comprising a reference to an electronic service interface specification;
retrieving the electronic service interface specification;
rendering content of the service request into a canonical message format defined in a canonical domain model referred in the electronic service interface specification; and
sending the message in the canonical format to a service provider using an established communication channel.

5. The method of claim 4 further comprising:
waiting for a return message if the message specified for a return message; and
receiving a signal of completion or failure of the business service request from the service requester.

6. A method for defining the execution of a business service by an electronic service request comprising:
defining a canonical data schema containing data type specifications;
defining an abstract electronic service interface, defining messages being received and sent by the electronic service, the message definitions referring to one or more of the data type specifications;
defining a business services specification referring to an electronic service interface specification;
electronic service specification in the electronic service registry;
defining a binding electronic service interface specification for a provider of an electronic service in the electronic service registry, the binding electronic service interface referring to an abstract electronic service interface specification, the abstract electronic service interface specification containing addressing and encoding information for delivering and receiving of messages to and from the service of the service provider;
defining a service provider capability; and
associating the service provider with one of the business services and referring to the binding electronic service interface specification of the service.

7. A method for defining the execution of a business service by an electronic service request comprising
defining a canonical data schema containing data type specifications in an electronic services registry;
defining an abstract electronic service interface specification in the electronic services registry, defining messages being received and sent by the service, the message definitions referring to one or more of the data type specifications;
defining business services in a business services registry, referring to an electronic service specification in the electronic service registry;
defining a binding electronic service interface specification for a provider of an electronic service in the electronic service registry, referring to an abstract electronic service interface specification, containing addressing and encoding information for delivering and receiving of messages to and from the service of the service provider; and
defining a service provider capability in the business services registry, associating the service provider with one of the business services and referring to the binding electronic service interface specification of the service.

8. The method of claim 7 wherein the business service delivery system binds a business service to an electronic service by:
retrieving a business service specification from the business services registry;
retrieving the set of service provider capabilities associated with the business service from the business services registry;
choosing a service provider among one or more electronic service providers having service provider capabilities associated with the business service;
retrieving the binding electronic service interface specification from the electronic services registry using the reference to the abstract electronic service interface specification contained in the business service specification;
retrieving the abstract electronic service interface specification from the electronic services registry using the reference to the abstract electronic service interface specification contained in the binding electronic service specification; and
setting up an electronic communication channel to the electronic service of the chosen service provider in accordance to the addressing and encoding information contained in the binding electronic service interface specification.

9. The method of claim 7 wherein:
service providers use a self registration tool to submit an application for a service provider capability; and
the business service delivery personnel use a tool to read the application and decide on an approval.

10. The method of claim 7 wherein:
the business service management system decides on the application automatically based on business rules.

11. A system comprising:
a business service delivery system for receiving a business service request and for delivering a business service in response to the business service request;
an electronic service registry comprising a set of canonical domain models and a set of electronic service interface specifications which comprise a definition of the electronic services interface; and
a business services registry containing a set of business services specifications that describe the properties of the business service, including data structures of input data provided by a requester.

12. The system of claim 11 wherein the business service delivery system is configured to bind the business service to an electronic service by:
retrieving a business service specification from the business services registry;
retrieving the electronic service interface specification from the electronic services registry using a reference to the electronic service interface specification contained in the business service specification; and
setting up an electronic communication channel to the electronic service provider in accordance to addressing and encoding information contained in the electronic service interface specification.

13. The system of claim 11 wherein the business service delivery system is configured to:
upon electronic request of a business service to the business service delivery system, render content of the service request into the canonical message format defined in the referred electronic service interface specification; and
send the message in the canonical format to the service using the established communication channel.

14. The system of claim 13 wherein the processor is further configured to:
wait for a return message, if so specified in the electronic service interface specification; and
return a signal of completion or failure of the business service request to the service requester.

15. The system of claim 11 further comprising a plurality of electronic service providers bound to the business service provider.

16. The system of claim 11 further comprising a communication layer for connecting the electronic service to the business service delivery system.

17. The system of claim 15 wherein the business services registry comprises:
a service provider entry for each of the plurality of electronic service providers; and
a service provider capability for each of the plurality of electronic service providers.

18. The system of claim 15 wherein:
a self registration tool for use by the service providers to submit an application for a service provider capability; and
a tool used by the business service delivery personnel to read the application and decide on the approval.

19. The system of claim 11 wherein a business service management system decides on the application automatically based on business rules.

20. The system of claim 11 wherein the electronic service registry comprises an electronic service binding specification referring to the electronic service interface specification and the electronic service interface specification refers to a communication channel that connects the service provider to the business service delivery system.

21. A computer executable medium comprising program code for:
defining at least one canonical data schema containing data type specifications;
defining at least one electronic service interface specification, the electronic service interface specification defining messages being received and sent by the electronic service, the messages defined referring to one or more of the data type specifications, and the messages defined also comprising addressing and encoding information for the delivery and receiving of messages to and from the electronic service; and
defining a business service specification referring to the electronic service interface specification.

22. The computer executable medium of claim 21 further comprising code for:
binding a business service to an electronic service specification, the binding step comprising:
retrieving the business service specification;
retrieving the electronic service interface specification using the reference to the electronic service interface specification; and
setting up an electronic communication channel to the electronic service provider in accordance with addressing and encoding information contained in the electronic service interface specification.

23. The computer executable medium of claim 21 further comprising code for:
receiving, from a service requester, an electronic request for a business service;
retrieving the associated business service specification;
rendering content of the service request into a canonical message format defined in the referred electronic service interface specification;
sending the message in the canonical format to a service provider using an established communication channel;
waiting for a return message, if so specified; and
receiving a signal of completion or failure of the business service request from the service requester.
